(19) United States
(12) Patent Application Publication
(10) Pub. No.: US 2019/0183277 A1
(43) Pub. Date: Jun. 20, 2019

(54) Portable Privacy Screen

(71) Applicant: ARTHUR PATRICK DIMICK, APTOS, CA (US)

(72) Inventor: ARTHUR PATRICK DIMICK, APTOS, CA (US)

(21) Appl. No.: 16/221,386

(22) Filed: Dec. 14, 2018

Related U.S. Application Data
(60) Provisional application No. 62/599,635, filed on Dec. 15, 2017.

(51) Int. Cl. A47H 23/04; B60J 1/20

(52) U.S. Cl. CPC A47H 23/04; B60J 1/2011

(57) ABSTRACT

An opaque fabric sheet for enabling increased privacy by detachable attachment to static objects or structural features. The method of use is appropriate when privacy is desired, such as changing clothes, approaching or departing from a beach, pool, athletic event, recreational activity, or costume event. The fabric sheet may be temporarily and removably attachable to structural elements, equipment, and/or vehicles, such as vehicular doors. One or more tab(s), magnet(s), hook and loop fastener assemblies, and/or lashing hook(s) may be attached to the fabric sheet. Various models of the sheet may also include one or more drawstrings to gather the sheet to better fit a given installation site. Two or more tabs may be visually distinguishable by placement of differing color markings. The sheet may include additional magnets that are positioned within the sheet and not within a tab. The device adapts to variations of positioning of vehicular doors such as front and side automobile doors, automobile hatchback doors, and other suitable vehicular doors.

### CO-PENDING APPLICATION

The present Nonprovisional Patent Application is a Continuation-in-Part Nonprovisional Patent Application to, and claims the priority date of, U.S. Provisional Patent Application Ser. No. 62/599,635 filed on Dec. 15, 2017. This U.S. Provisional Patent Application Ser. No. 62/599,635 is hereby incorporated by reference in its entirety and for all purposes into the present Nonprovisional Patent Application.

### FIELD OF THE INVENTION

The present invention relates to the field of portable privacy screens or drapes and, more particularly, to a portable privacy screen or drape for use with a vehicle.

### BACKGROUND

The subject matter discussed in the background section should not be assumed to be prior art merely as a result of its mention in the background section. Similarly, a problem mentioned in the background section or associated with the subject matter of the background section should not be assumed to have been previously recognized in the prior art. The subject matter in the background section merely represents different approaches, which in and of themselves may also be inventions.

There are many instances in which it becomes necessary to make a change of clothes in locations where it otherwise would be difficult to achieve. For example, it may be desirable to quickly change clothes after going to the beach or swimming, or after a sporting event or other recreational sctivity. Depending on the circumstance, it may be prohibitive to do so in a public location. There may not be an easily accessible room in which to change or there may be too many people needing a space or room in which to change clothes. Accordingly, there is a need to provide a canopy assembly that may be easily setup and folded for storage.

There would be a great advantage in providing a privacy that could be used in conjunction with a vehicle. A great advantage would be realized by providing a privacy screen assembly that could be temporarily or removably connected to a vehicle, and disposed in communication with the exterior of a door of a vehicle and with a roof, door, or other structural element of the vehicle. A further advantage would be realized by providing a privacy screen comprising flexible or collapsible materials so that it may conveniently be folded and stored.

### SUMMARY AND OBJECTS OF THE INVENTION

The method of the present invention (hereinafter, “the invented method”) is directed towards providing and applying a screen assembly used to enable increased privacy to a human user when the user intends to change clothes, or otherwise risk visual exposure while disrobed or otherwise in need of privacy. Appropriate instances for application of the invented method include going to or from a beach, a swimming pool, a sporting event, or during a similar circumstance. A feature of the privacy screen according to the invented method is that certain alternate preferred embodiments of the present invention may be used in conjunction with a vehicle. The inside of certain alternate preferred embodiments of the present invention may be disposed adjacent to a vehicle and in communication with both the exterior of a one or more doors of the vehicle and optionally additional structural elements of the vehicle. Thus, an individual may change clothes, and subsequently enter the temporarily coupled vehicle directly without having to exit a privacy volume defined and formed in accordance with the invented method.

Towards these and other objects of the method of the present invention the invented method that are made obvious to one of ordinary skill in the art in light of the present disclosure, the invented method provides a system (hereinafter, “the invented screen”) for creating a volume that provides enhanced privacy from external visual observation.

A first preferred embodiment of the invented screen may include a fabric sheet having a top edge; a first magnet located within a first tab, the first tab extending from the sheet; a second magnet located within a second tab, the second tab extending from the sheet; and/or a drawstring assembly, the drawstring assembly having a cord and a tightening element, and the cord having a first cord end and a second cord end. The tightening element is preferably coupled with the cord in a way that permits adjustment by sliding and disposed between the first cord end and the second cord end, and the first cord end is attached to the sheet, and the second cord end is attached to the sheet distally from the first cord end.

Other alternate preferred embodiments of the invented sheet may additionally or optionally include one or more of the following aspects: (1.) a fabric sheet with a top edge located distally from a bottom edge; (2.) a left edge located distally from a right edge; (3.) an upper left corner located distally from a bottom right corner; (4.) an upper right corner located distally from a bottom left corner; (5.) a first drawstring assembly, with the drawstring assembly having a cord and a tightening element, and the cord having a first cord end and a second cord end; (6.) one or more additional drawstring assemblies, attached to the sheet at any point; (7.) a plurality of fabric tabs, wherein each tab may entirely, or at least partially, encompass one or more magnets.

Still other alternate preferred embodiments of the invented sheet may additionally or optionally include one or more of the following aspects: (1.) a first tab color and a second tab color, such that the first tab is visibly distinguishable by surface coloration from the second tab; (2.) one or more additional tabs attached at any point on the sheet; (3.) one, two, or more tabs, each tab for positioning at least one magnet and extending proximally from a same corner of the sheet; (4.) one, two, or more tabs, each tab for positioning at least one magnet and each tab extending proximally from a top edge, bottom edge, or side edge; (5.) a plurality of magnets attached to any point, side, or corner of the sheet, or included as part of any tab; (6.) one or more lashing hooks attached to any point, side or corner on the sheet; (7.) a plurality of lashing hooks comprising a hook-shaped piece of metal, plastic, or any other material, and/or an element that physically connects the hook-shaped piece to the sheet such as a strap, chain, and/or loop of fabric, where the lashing hooks can be attached to any point, side, or corner of the sheet.

Even other alternate preferred embodiments of the invented sheet may additionally include a method for coupling portable privacy screen to a vehicle, the vehicle having at least one vehicle door coupled in a way that is rotatable, and the screen comprising a sheet and at least two magnetic tabs and a drawstring coupled to the sheet, the method comprising: (1.) rotating the vehicle door from a closed position into an alternate position; (2.) removably coupling at least one of the magnetic tabs to the vehicle and draping a first portion of the sheet along an exterior of the vehicle door; (3.) removably coupling at least one other of the magnetic tabs to the vehicle and draping a second portion of the sheet between the vehicle door and the vehicle.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

### BRIEF DESCRIPTION OF THE FIGURES

The detailed description of some embodiments of the invention is made below with reference to the accompanying figures, wherein like numerals represent corresponding parts of the figures.

FIG. 1 is a front view of a first alternate preferred embodiment of the present invention (hereinafter, “the first version”) comprising a fabric and a plurality of tabs extending therefrom, wherein the tabs each encompass a magnet;

FIG. 2 is a perspective view of the first version of FIG. 1 detachably attached with a vehicle;

FIG. 3 is a front view of the second alternate preferred embodiment of the present invention (hereinafter, “the second version”), having additional pairs of tabs extending from corners of the first version of FIG. 1;

FIG. 4 is a front view of the second version of FIG. 3 further comprising a drawstring assembly;

FIG. 5 is a front view of the second version of FIG. 4 further comprising an additional drawstring assembly;

FIG. 6 is a front view of the second version of FIG. 3 further comprising two lashing hook assemblies and the drawstring assemblies of FIG. 5;

FIG. 7 is a detailed front view of the exemplary drawstring assembly of FIG. 4.

FIG. 8A is a detailed cut-away front view of a tab encompassing a magnet of the first version of FIG. 1;

FIG. 8B is a detailed side view of a tab encompassing a magnet of the first version of FIG. 1 in an alternate means;

FIG. 8C is a detailed side view of a tab of the first version of FIG. 1 modified to include two magnets;

FIG. 9A is a detailed perspective view of a first lashing hook of FIG. 6;

FIG. 9B is a detailed perspective view of a second lashing hook of FIG. 6;

FIG. 10A is a detailed perspective view of an optional hook-and-loop fastener assembly in an open state and attached to the first version of FIGS. 1; and

FIG. 10B is a detailed perspective view of an optional hook-and-loop fastener assembly in a closed state and attached to the first version of FIG. 1.

### DETAILED DESCRIPTION

In the following detailed description of the invention, numerous details, examples, and embodiments of the invention are described. However, it will be clear and apparent to one skilled in the art that the invention is not limited to the embodiments set forth and that the invention can be adapted for any of several applications.

It is to be understood that this invention is not limited to particular aspects of the present invention described, as such may, of course, vary. It is also to be understood that the terminology used herein is for the purpose of describing particular aspects only, and is not intended to be limiting, since the scope of the present invention will be limited only by the appended claims. Methods recited herein may be carried out in any order of the recited events which is logically possible, as well as the recited order of events.

Where a range of values is provided herein, it is understood that each intervening value, to the tenth of the unit of the lower limit unless the context clearly dictates otherwise, between the upper and lower limit of that range and any other stated or intervening value in that stated range, is encompassed within the invention. The upper and lower limits of these smaller ranges may independently be included in the smaller ranges and are also encompassed within the invention, subject to any specifically excluded limit in the stated range. Where the stated range includes one or both of the limits ranges excluding either or both of those included limits are also included in the invention.

Unless defined otherwise, all technical and scientific terms used herein have the same meaning as commonly understood by one of ordinary skill in the art to which this invention belongs. Although any methods and materials similar or equivalent to those described herein can also be used in the practice or testing of the present invention, the methods and materials are now described.

It must be noted that as used herein and in the appended claims, the singular forms “a”, “an”, and “the” include plural referents unless the context clearly dictates otherwise. It is further noted that the claims may be drafted to exclude any optional element. As such, this statement is intended to serve as antecedent basis for use of such exclusive terminology as “solely,” “only” and the like in connection with the recitation of claim elements, or use of a “negative” limitation.

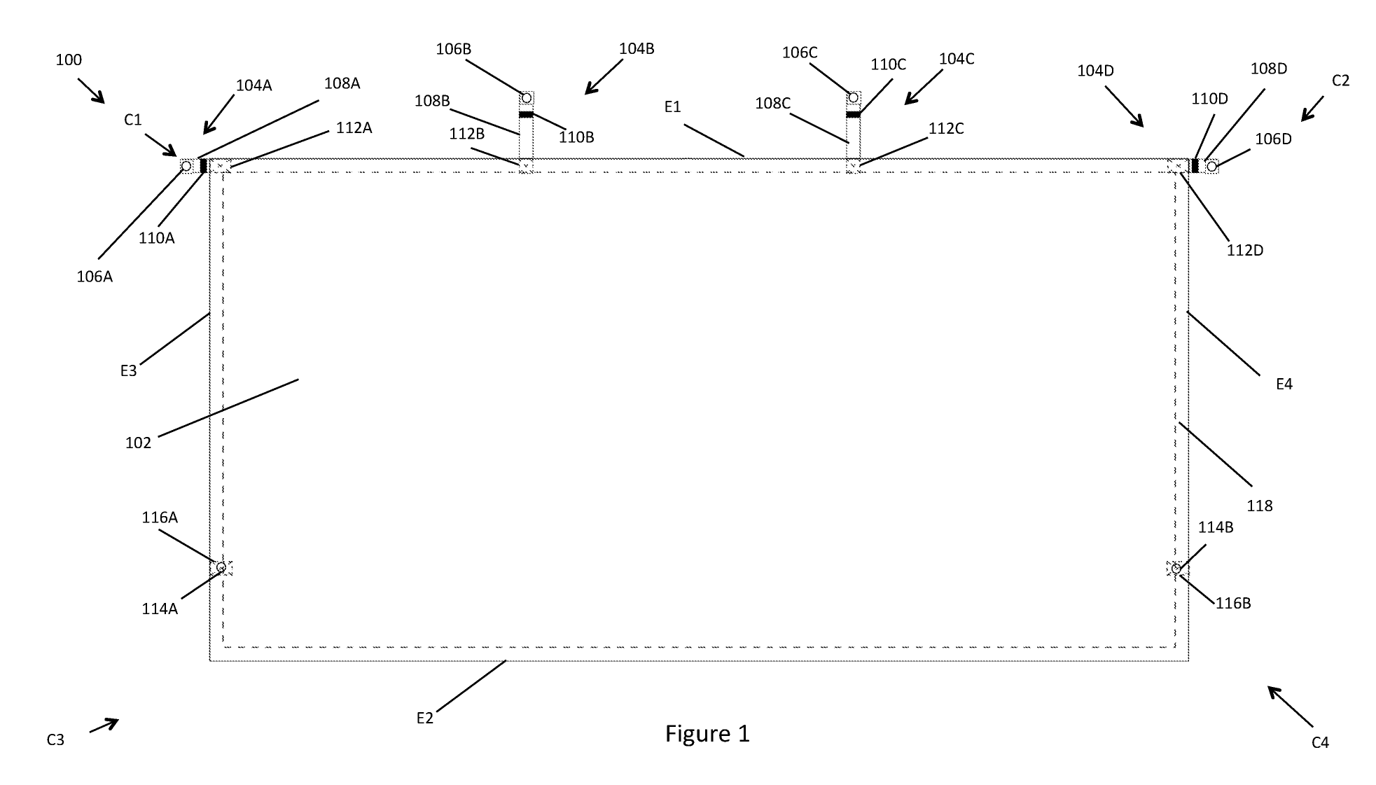

Referring now generally to the Figures and particularly to FIG. 1, FIG. 1 is a a front cut-away view of a first alternate preferred embodiment of the present invention 100 (hereinafter, “the first version” 100) comprising a sheet 102 and a plurality of magnetic tab assemblies 104A-104D extending therefrom, wherein the tab assemblies 104A-104D (hereinafter, “tabs” 104A-104D) each include a magnet 106A-106D located within a tab length 108A-108D. The fabric sheet 102 presents a quadrilateral shape and is defined by four edges E1-E4 variously join to form four corners C1-C4. It is understood that certain alternate preferred embodiments of the present invention include sheets define shapes that are not quadrilateral and do not include straight edges or corners.

The four magnetic tabs 104A-104D are coupled with and each separately extend from the sheet 102 and house a separate magnet 106A-106D shown in cut-away view. The first tab 104A is coupled at the first corner Cl of the fabric sheet 102 and includes a first magnet 106A that is encased in a first tab length 108A. The first tab length 108A is optionally color coded with a first colored surface 110A, wherein it is understood that the first colored surface 110A may extend over all or only a portion of the outer surface of the first tab length 108A. A first tab thread 112A is sewn into both the first tab length 108A and the fabric sheet 102 to attach the first tab 104A securely to the fabric sheet 102.

It is understood that in certain alternate preferred embodiments of the present invention that the fabric sheet 102 and one or more tab lengths 108A-108D may be made of a unified fabric of a single, whole sheet.

The second tab 104B is coupled at the first edge E1 of the fabric sheet 102 between the first tab 104A and the third tab 104C. The second tab 104B includes a second magnet 106B that is encased in a second tab length 108B. The second tab length 108B is optionally color coded with a second colored surface 110B, wherein it is understood that the second colored surface 110B may extend over all or only a portion of the outer surface of the second tab length 108B. A second tab thread 112B is sewn through both the second tab length 108B and the fabric sheet 102 to attach the second tab 104B securely to the fabric sheet 102.

The third tab 104C is coupled at the first edge E1 of the fabric sheet 102 between the second tab 104B and the fourth tab 104D. The third tab 104C includes a third magnet 106C that is encased in a third tab length 108C. The third tab length 108C is optionally color coded with a third colored surface 110C, wherein it is understood that the third colored surface 110C may extend over all or only a portion of the outer surface of the third tab length 108C. A third tab thread 112C is sewn through both the third tab length 108C and the fabric sheet 102 to attach the third tab 104C securely to the fabric sheet 102.

The fourth tab 104D is coupled at the second corner C2 of the fabric sheet 102 and includes a fourth magnet 106D that is encased in a fourth tab length 108D. The fourth tab length 108D is optionally color coded with a fourth colored surface 110D, wherein it is understood that the fourth colored surface 110D may extend over all or only a portion of the outer surface of the fourth tab length 108D. A fourth tab thread 112D is sewn through both the fourth tab length 108D and the fabric sheet 102 to attach the fourth tab 104D securely to the fabric sheet 102.

The tab lengths 108A-108D are each sufficiently sized and shaped to fully buffer and enclose a respective magnets 106A-106D from contact with external surfaces during operational placement of the version 100.

Two additional magnets 114A & 114B are respectively encased between the fabric sheet 102 and fabric elements 116A & 116B. A fabric thread 118 is sewn through both of the fabric elements 116A 116B and the fabric sheet 102 to attach the additional magnets 114A & 114B securely to the fabric sheet 102.

The magnets 106A-106D, 114A & 114B may be or comprise (a.) Neodymium material shaped to present a circular planar surface having a diameter of 1.26″ and a height dimension orthogonal to the circular planar surface of 0.06″ thick N52 magnet exhibiting a 8.5 pound pull, (b.) Neodymium material shaped to present an alternate circular planar surface having a diameter of 0.375″ and a height dimension orthogonal to the alternate circular planar surface of 0.06″ thick N52 magnet exhibiting a 1.5 pound pull, or (c.)

other suitable magnetic material known in the art.

The tab lengths 108A-108D and fabric sheet 102 may be or comprise a durable and water resistant synthetic or natural fabric in singularity, blended, or in a suitable alternate combination known in the art, to include but not limited to, a knit fabric, nylon, rayon, polyester, spandex™, canvas, cotton, silk, hemp and other suitable fabric known in the art. The tab threads 112A-112D & fabric thread 118 may be or comprise a durable and water resistant synthetic or natural material in singularity or in combination, to include but not limited to, nylon, rayon, a polyester, canvas, cotton, silk, hemp, and other suitable thread material known in the art. In various alternate preferred embodiments of the fabric edges E1-E4 may individually present length dimensions within the range of from 4.0 feet to 20 feet.

One or more magnets 106A-106D, 114A & 114B may be or comprise (a.) Neodymium material shaped to present a circular planar surface having a diameter of 1.26″ and a height dimension orthogonal to the circular planar surface of 0.06″ thick N52 magnet exhibiting a 8.5 pound pull, (b.) Neodymium material shaped to present an alternate circular planar surface having a diameter of 0.375″ and a height dimension orthogonal to the alternate circular planar surface of 0.06″ thick N52 magnet exhibiting a 1.5 pound pull.

The colors of the tab colored surfaces 110A-110B may be variously colored or multi-colored, or alternately one or more tab colored surfaces 110A-110B may be similarly colored or multi-colored.

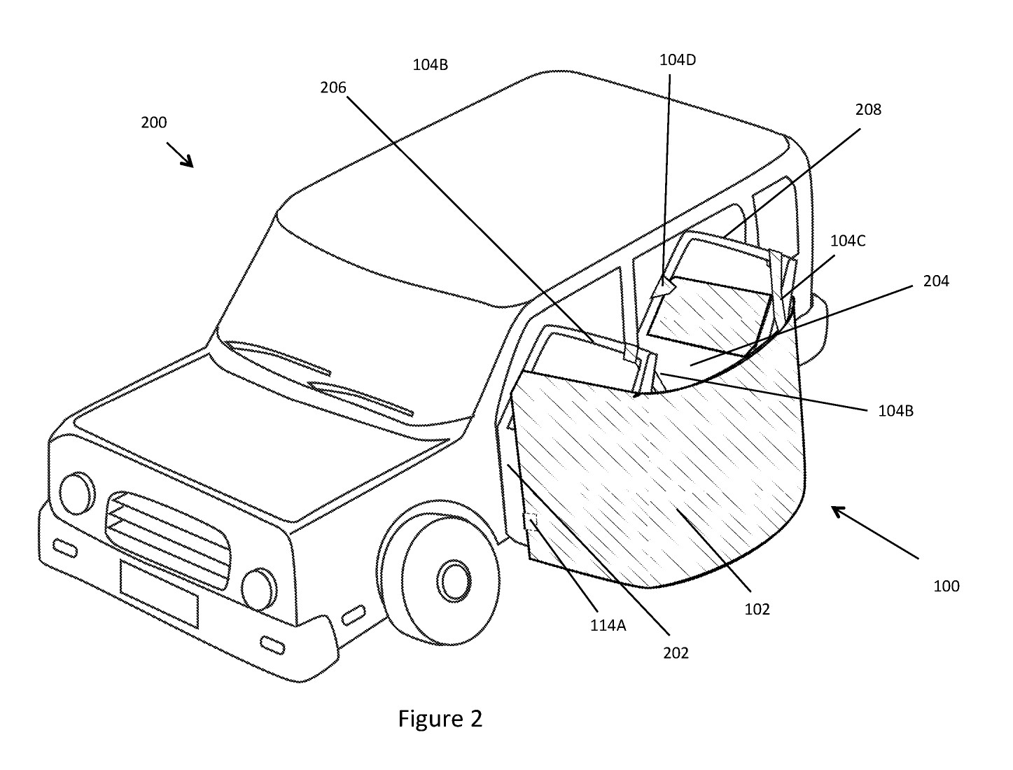

Referring now generally to the Figures and particularly to FIG. 1 and FIG. 2, FIG. 2 is a front view of the first version 100 of FIG. 1 detachably attached with a vehicle 200. The vehicle 200 includes a front door 202 and a passenger door 204, wherein the front door 202 and the passenger door 204 includes metal materials that are magnetically attractive to the magnets 106A-106D. As shown in FIG. 2, the fabric sheet 102 is positioned externally along the front door 202, whereby the fabric sheet 102 relies upon the front door 200 to support maintaining a static position of the fabric sheet 102 relative to the front door 202 and to resist an undesirable flapping or other separation from the front door 202 due to momentum received by the fabric sheet 102 from exposure to wind and precipitation.

The magnets 106A-106D, 114A & 114B do not make direct physical contact with the car 200. The tab lengths 108A-108D are respectively individually disposed between one enclosed magnet 106A-106D and the car 200. The fabric 102 and/or the fabric elements 116A & 116B are respectively disposed between each additional magnet 114A & 114B and the car 200.

The second tab 104B wraps around from an interior side of the front door 202 to the exterior of the front door 202 and the second magnet 106B is detachably magnetically engaged with a magnetically attractive upper front door element 206 of the front door 202. The first tab 104A (as shown in FIG. 1) wraps from the exterior of the front door 200 around to an interior side of the front door 202 and the first magnet 106A is magnetically engaged with the upper front door element 206.

The first additional magnet 114A is detachably magnetically coupled with the front door 202 and the second additional magnet 114B (although not presented in FIG. 2) is detachably magnetically coupled with the rear door 204.

The third tab 104C wraps around from an interior side of the side door 204 to an exterior of the side door 204 and the third magnet 106C is magnetically engaged with a magnetically attractive upper side door element 208 of the side door 204. The fourth tab 104D (as shown in FIG. 1) wraps from the interior side of the side door 204 around to an exterior side of the side door 204 and the fourth magnet 106D is magnetically engaged with the upper side door element 208.

The first version 100 flexibly adapts to variations of positioning of vehicular doors 202 & 204, to include fully open, partially open and closed positions of the vehicular doors 202 & 204, or other suitable vehicular doors, such as automobile hatchback doors. The first version 100 further flexibly adapts about vehicle windows, non-door structural elements of vehicles, other equipment, and other objects.

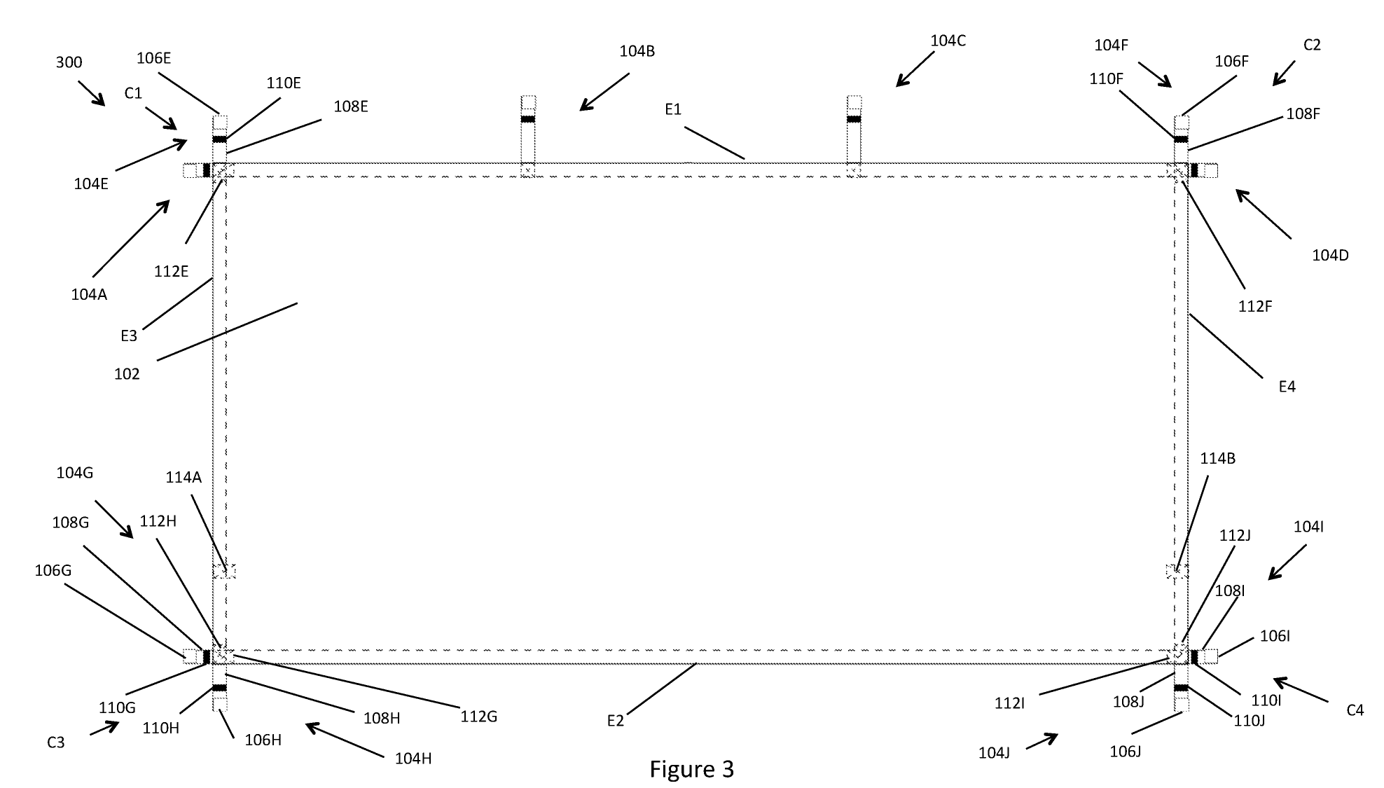

Referring now generally to the Figures and particularly to FIG. 3, Figure is a front cut-away view of a second alternate preferred embodiment of the present invention 300 (hereinafter, “the second version” 300) comprising the first version 100 and having additional of tabs 104E-104J extending from corners of the first version 100.

The fabric sheet 102 presents a quadrilateral shape and is defined by four edges E1-E4 variously join to form four corners C1-C4. It is understood that certain alternate preferred embodiments of the present invention include sheets define shapes that are not quadrilateral and do not include straight edges or corners.

A fifth tab 104E is coupled to the fabric sheet 102 at the first corner C1 and extends from the first edge E1. The fifth tab 104E includes a fifth magnet 106E that is encased in a fifth tab length 108E. The fifth tab length 108E is optionally color coded with a fifth colored surface 110E, wherein it is understood that the fifth colored surface 110E may extend over all or only a portion of the outer surface of the fifth tab length 108E. A fifth tab thread 112E is sewn into both the fifth tab length 108E and the fabric sheet 102 to attach the fifth tab 104E securely to the fabric sheet 102.

A sixth tab 104F is coupled to the fabric sheet 102 at the second corner C2 and extends from the first edge E1. The sixth tab 104F includes a sixth magnet 106F that is encased in a sixth tab length 108F. The sixth tab length 108F is optionally color coded with a sixth colored surface 110F, wherein it is understood that the sixth colored surface 110F may extend over all or only a portion of the outer surface of the sixth tab length 108F. A sixth tab thread 112F is sewn into both the sixth tab length 108F and the fabric sheet 102 to attach the sixth tab 104F securely to the fabric sheet 102.

A seventh tab 104G is coupled to the fabric sheet 102 at the third corner C3 and extends from the third edge E3. The seventh tab 104G includes a seventh magnet 106G that is encased in a seventh tab length 108G. The seventh tab length 108G is optionally color coded with a seventh colored surface 110G, wherein it is understood that the seventh colored surface 110G may extend over all or only a portion of the outer surface of the seventh tab length 108G. A seventh tab thread 112G is sewn into both the seventh tab length 108G and the fabric sheet 102 to attach the seventh tab 104G securely to the fabric sheet 102.

An eighth tab 104H is coupled to the fabric sheet 102 at the third corner C3 and extends from the second edge E2. The eighth tab 104H includes an eighth magnet 106H that is encased in an eighth tab length 108H. The eighth tab length 108H is optionally color coded with an eighth colored surface 110H, wherein it is understood that the eighth colored surface 110H may extend over all or only a portion of the outer surface of the eighth tab length 108H. An eighth tab thread 112H is sewn into both the eighth tab length 108H and the fabric sheet 102 to attach the eighth tab 104H securely to the fabric sheet 102.

A ninth tab 104I is coupled to the fabric sheet 102 at the fourth corner C4 and extends from the fourth edge E4. The ninth tab 104I includes a ninth magnet 106I that is encased in a ninth tab length 108I. The ninth tab length 108I is optionally color coded with a ninth colored surface 110I, wherein it is understood that the ninth colored surface 110I may extend over all or only a portion of the outer surface of the ninth tab length 108I. A ninth tab thread 112I is sewn into both the ninth tab length 108I and the fabric sheet 102 to attach the ninth tab 104I securely to the fabric sheet 102.

A tenth tab 104J is coupled to the fabric sheet 102 at the fourth corner C4 and extends from the second edge E2. The tenth tab 104J includes a tenth magnet 106J that is encased in a tenth tab length 108J. The tenth tab length 108J is optionally color coded with a tenth colored surface 110J, wherein it is understood that the tenth colored surface 110J may extend over all or only a portion of the outer surface of the tenth tab length 108J. A tenth tab thread 112J is sewn into both the tenth tab length 108J and the fabric sheet 102 to attach the tenth tab 104J securely to the fabric sheet 102.

The tab lengths 108E-108J and fabric sheet 102 may be or comprise a durable and water resistant synthetic or natural fabric in singularity, blended, or in a suitable alternate combination known in the art, to include but not limited to, a knit fabric, nylon, rayon, polyester, spandex™, canvas, cotton, silk, n and other suitable fabric known in the art.

The tab threads 112E-112J may be or comprise a durable and water resistant synthetic or natural material in singularity or in combination, to include but not limited to, nylon, rayon, a polyester, canvas, cotton, silk, hemp, and other suitable thread material known in the art.

In a preferred deployment of the second version 300 with the car 200, the magnets 106A-106J, 114A & 114B do not make direct physical contact with the car 200. The tab lengths 108A-108J are respectively individually disposed between one enclosed magnet 106A-106J and the car 200. The fabric 102 and/or the fabric elements 116A & 116B are respectively disposed between each additional magnet 114A & 114B and the car 200.

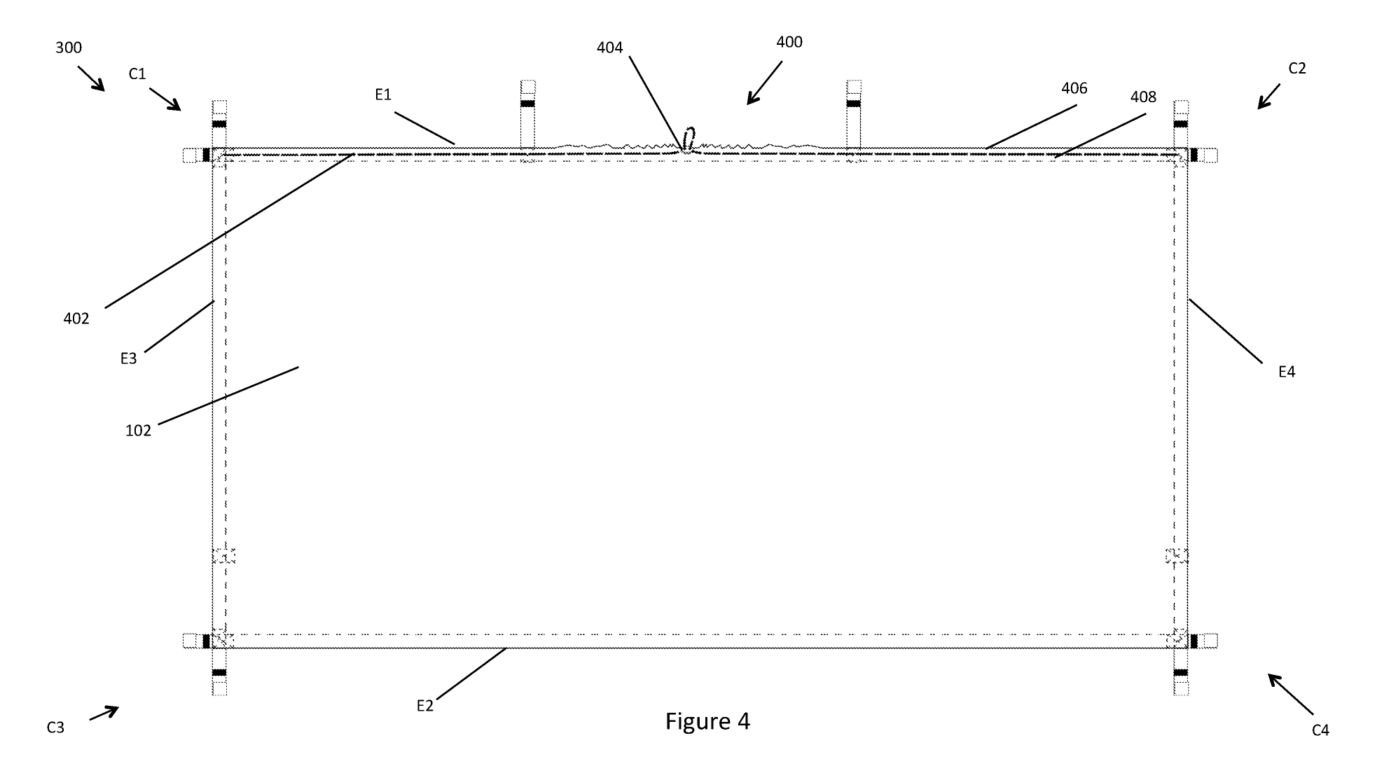

Referring now generally to the Figures and particularly to FIG. 4, FIG. 4 is a front cut away view of the second version 300 further comprising a drawstring assembly 400. The drawstring assembly 400 includes a drawstring cord 402 and a cord lock 404. The drawstring cord 402 traverses through a casing 406; the casing 406 is formed by doubling over and sewing the fabric sheet 102 to itself with a fabric thread 408. The drawstring cord 402 traverses out of the casing 406 to be captured and pinched by the cord lock 404, whereby the to is adapted to allow a user to choose to, and effectively limit or adjust, a maximum length of displacement of the first corner C1 and the second corner C2.

The drawstring cord 402 may be or comprise a durable and water resistant synthetic or natural material in singularity or in combination, to include but not limited to, nylon, rayon, a polyester, canvas, cotton, silk, hemp, and other suitable cord material known in the art.

The fabric thread 408 may be or comprise a durable and water resistant synthetic or natural material in singularity or in combination, to include but not limited to, nylon, rayon, a polyester, canvas, cotton, silk, hemp, and other suitable thread material known in the art.

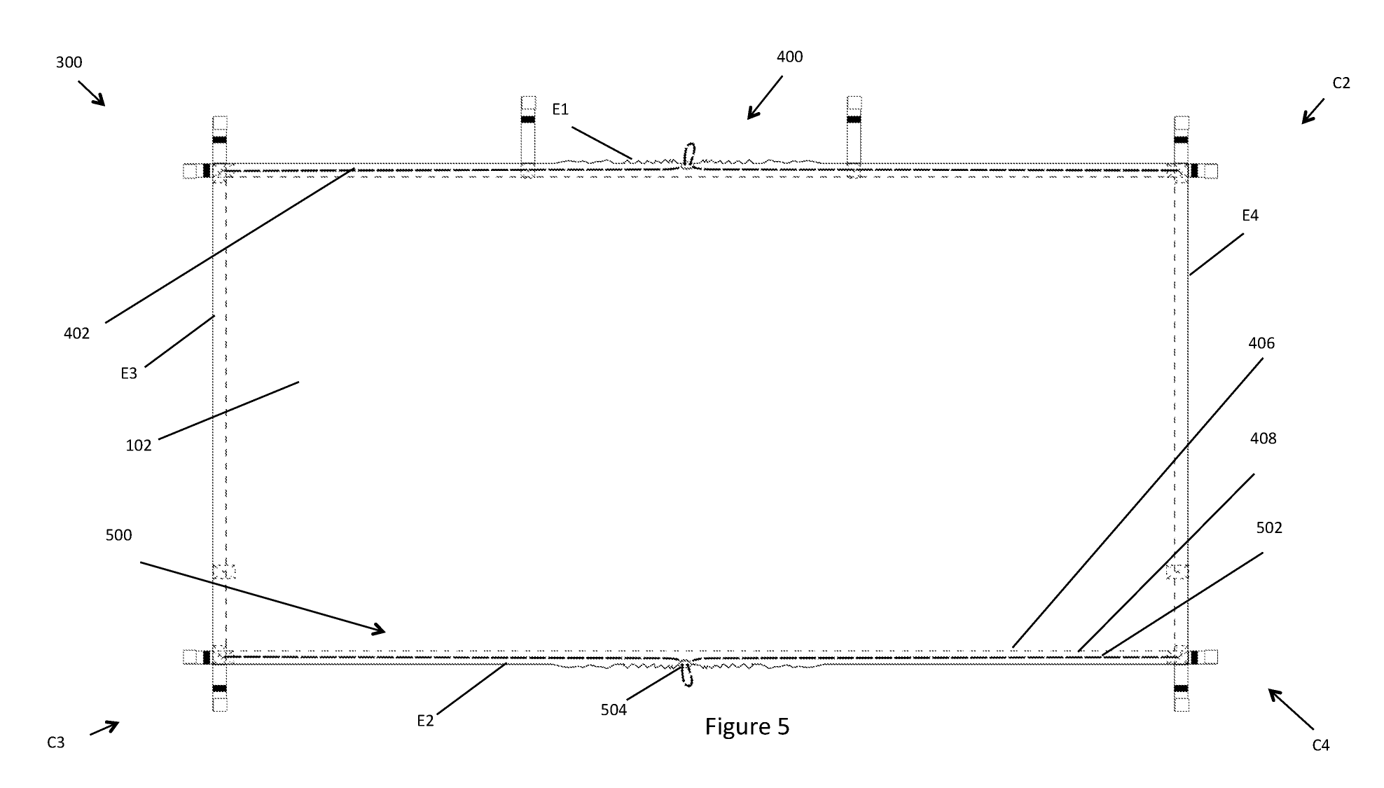

Referring now generally to the Figures and particularly to FIG. 5, FIG. 5 is a front view of the second version 300 further comprising an additional drawstring assembly 500. The additional drawstring assembly 500 includes a second drawstring cord 502 and a second cord lock 504. The second drawstring cord 502 traverses through the lengths of the casing 406; as discussed in referenced to FIG. 4, the casing 404 is formed by doubling over and sewing the fabric sheet 102 to itself with the fabric thread 408. The second drawstring cord 402 may be or comprise a durable and water resistant synthetic or natural material in singularity or in combination, to include but not limited to, nylon, rayon, a polyester, canvas, cotton, silk, hemp, and other suitable cord material known in the art.

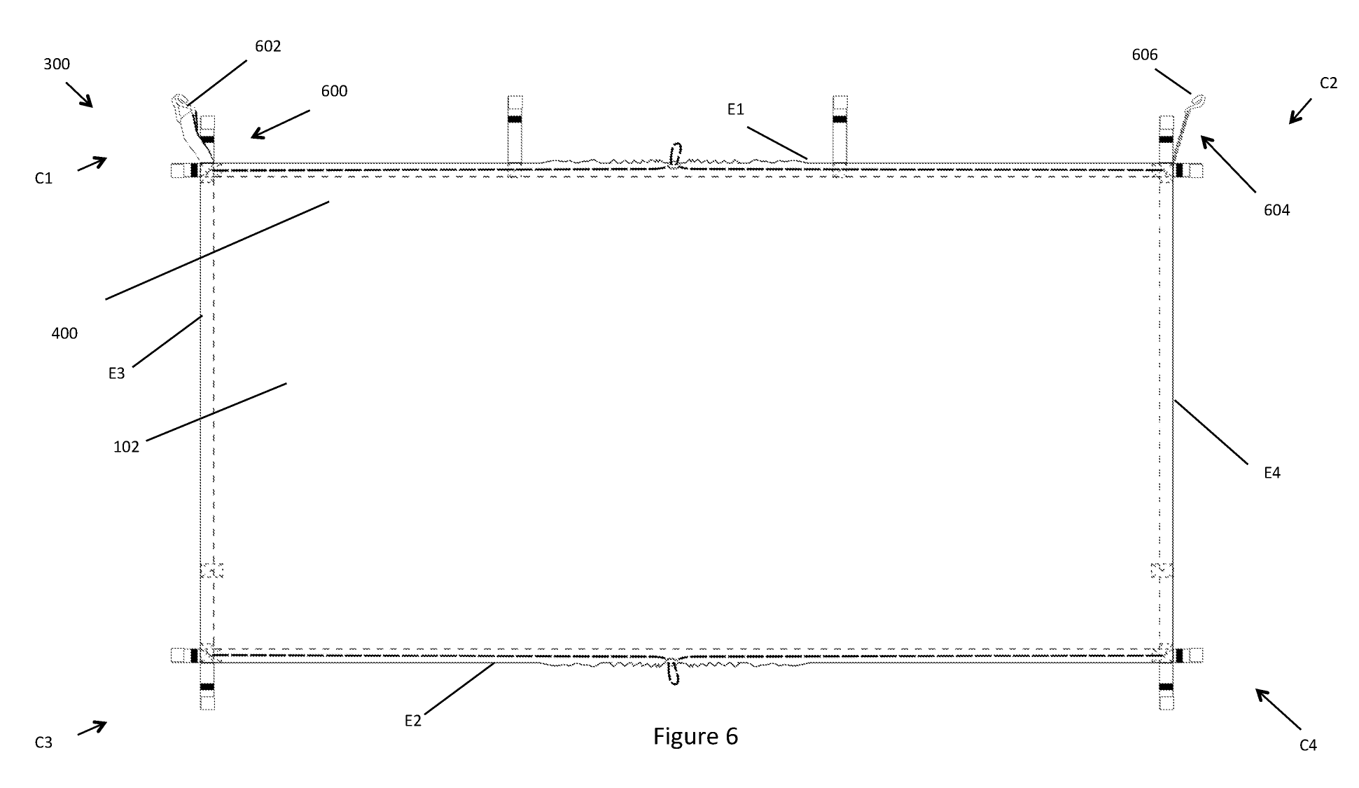

Referring now generally to the Figures and particularly to FIG. 6, FIG. 6 is a front view of the second version further comprising a first lashing hook assembly 600 that includes a first lashing hook 602 and a second lashing hook assembly 604 that includes a second lashing hook 606.

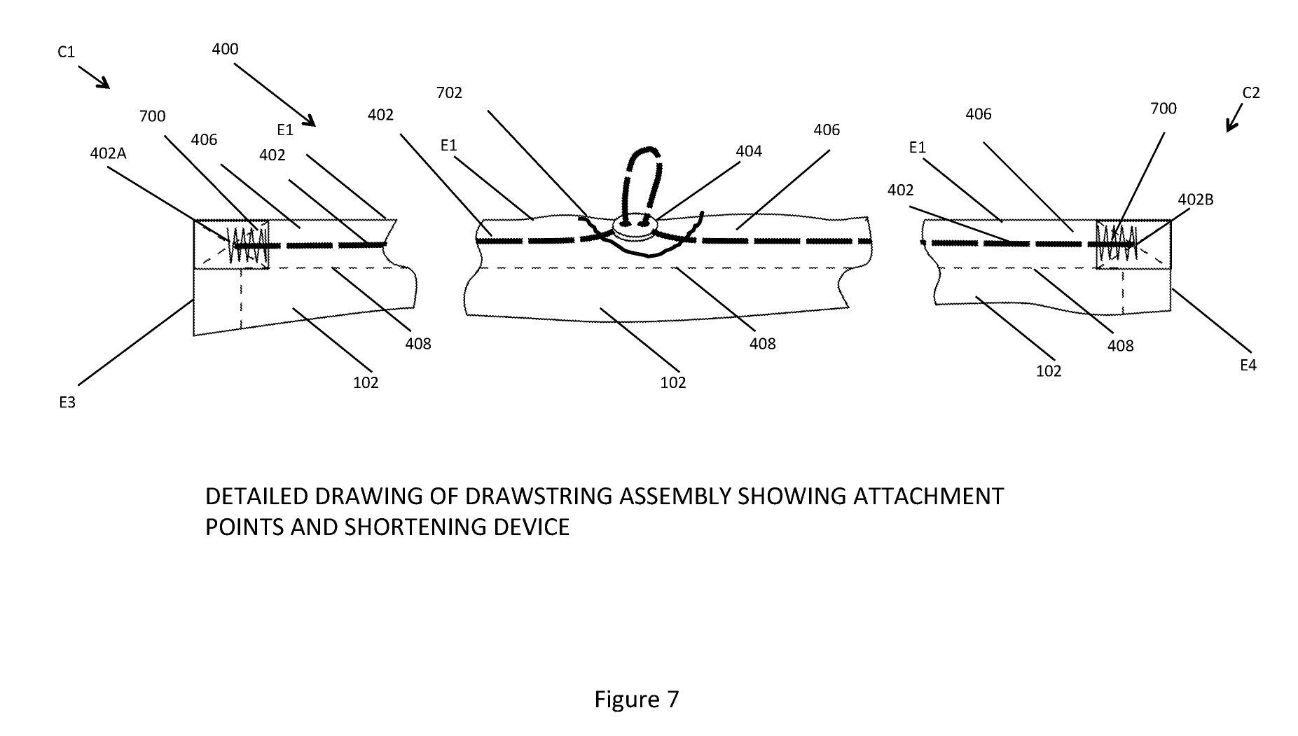

Referring now generally to the Figures and particularly FIG. 7, FIG. 7 is a front cut away view of the drawstring assembly 400 shown in FIG. 4, in the drawstring assembly 400 is located along a top edge E1 of the privacy screen.

The drawstring assembly 400 is supported in connection with the fabric sheet 102 by first a doubling over the fabric sheet 102 along the edges E1-E4 and a sewing of a portion of the fabric sheet folded over in place with the fabric thread 408 to form the casing 406. The casing 406 comprises a hollow tube of the sheet fabric 102 located proximate to the edges E1-E4 through which the drawstring cord 402 subsequently traverses.

Regarding the drawstring cord 402, each end of the drawstring cord 402 are secured at each end within the casing 406 by a drawstring thread 700; the casing 406 includes a drawstring aperture 702 such that the drawstring cord 402 can be pulled through the hole drawstring aperture 702 for the purposes of tightening and loosening the drawstring assembly 400, and additionally, a cord lock 404 is attached to the drawstring 402 for the purpose of locking the drawstring 402 at a given setting of tightness or looseness as manually controlled by the user.

It is understood that the second drawstring assembly 500 may be assembled effectively with identical components as the drawstring assembly 400.

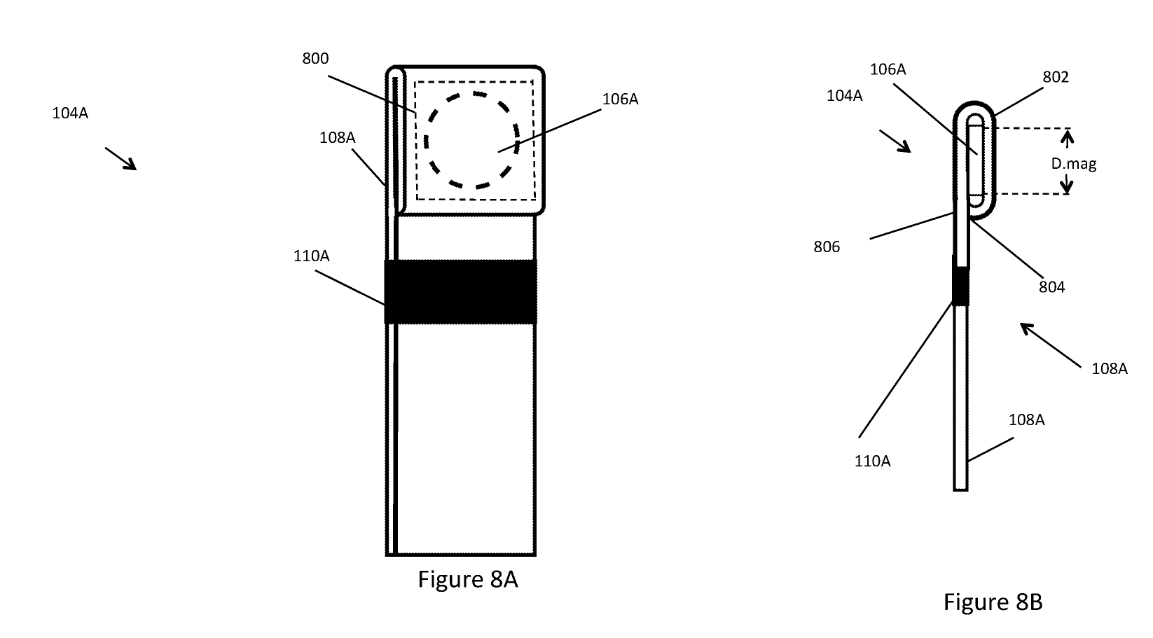

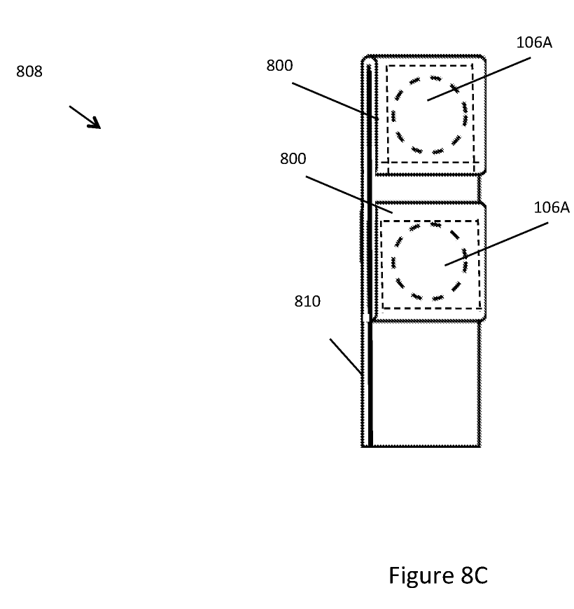

Referring now generally to the Figures and particularly FIG. 8A, FIG. 8A is a detailed cut-away front view of the first tab 104A. The first tab length 108A encases the first magnet 106A. Optional inner tab thread 800 surrounds the first magnet 106A threads through the folded over first tab length 108A that encases the first magnet 106A.

The optional first colored surface 110A may extend over all or only a portion of the outer surface of the first tab length 108A. The optional inner tab thread 800 may be or comprise a durable and water resistant synthetic or natural material in singularity or in combination, to include but not limited to, nylon, rayon, a polyester, canvas, cotton, silk, hemp, and other suitable thread material known in the art.

Referring now generally to the Figures and particularly FIG. 8B, FIG. 8B is a cut away side view of the first tab 104A with an alternate enclosure means of the first magnet 106A by the first tab length 108A. The first tab length 108A forms a tab loop 802 to encase the first magnet 106A. The tab loop 802 is formed by attaching a first tab length end 804 of the first tab length 108A at a central tab location 1806 of the first tab length 108A. The attachment of the first tab length end 804 of the first tab length 108A may be accomplished with adhesive (not shown) or sewing the first tab length end 804 of the first tab length 108A at the central tab location 806 with an extra length (not shown) of the inner tab thread 800. A magnet diameter D.Mag of the circular first magnet 106A is preferably in the range of from 0.1 inch to 1.0 inch.

17

Referring now generally to the Figures and particularly FIG. 8C, FIG. 8C is a detailed cut-away front view of an alternate tab 808 that encases two first magnets 106A. A modified tab length 810 encases both first magnets 106A. Separate lengths of the inner tab thread 800 surrounds each first magnet 106A wherein stiches of the inner tab thread 800 pass twice through the folded-over modified tab length 810 to form an encasement of the two first magnets 106A. The modified tab length 810 may be or comprise a durable and water resistant synthetic or natural fabric in singularity, blended, or in a suitable alternate combination known in the art, to include but not limited to, a knit fabric, nylon, rayon, polyester, spandex™, canvas, cotton, silk, hemp and other suitable fabric known in the art.

The alternate tab 808 having two magnets 106A enables magnetic coupling with two sides of a same door 202 & 204 or other object.

Preferably the tabs 104A-104J & 808 extend away from the fabric sheet 102 in a length dimension within the range of from 1.0 inch to one yard, and in a width dimension that is orthogonal to the height dimension within a range of from 0.25 inches to one foot.

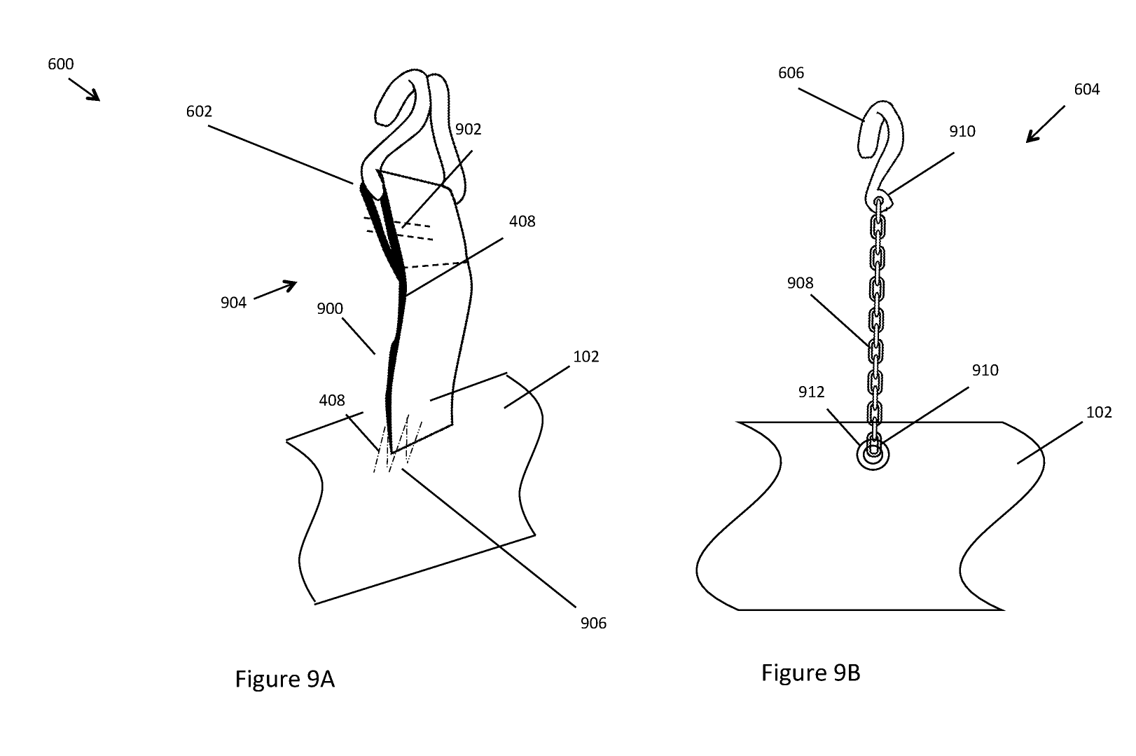

Referring now generally to the Figures and particularly FIG. 9A, FIG. 9A is a detailed perspective cut-away view of the first version lashing hook assembly 600, as shown for the lashing hook assembly 600 in FIG. 6. This first alternate lashing hook assembly 600 that comprises the first hook 602 and a hook strap 900. The hook strap 900 is passed through the first hook base 902 of the first hook 602, folded double, and attached to itself by stitching with the fabric thread 408, thus forming a looped strap 904 around the first hook base 902. The other end 906 of the first hook strap 900 is sewn to the first edge El of the fabric sheet 102 fabric thread 408.

Preferably the hook strap 900 extends away from the fabric sheet 102 in a hook strap length dimension within the range of from 1.0 inch to one yard, and in a hook strap width dimension that is orthogonal to the hook strap height dimension within a range of from 0.25 inches to one foot.

Referring now generally to the Figures and particularly FIG. 9B, FIG. 9B is a detailed perspective view of the second lashing hook assembly 604. The second lashing hook assembly 604 comprises the second hook 606 coupled with a hook chain 908. The hook chain 908 is linked at a hook hole 910 of the hook 606 at the base of the hook 606. The other end of the hook chain 908 is attached to the first edge El of the fabric sheet 102 at a sheet chain end link 910 to a fabric sheet hole 912 in the fabric sheet 102.

Preferably the hook chain 908 extends away from the fabric sheet 102 in a chain length dimension within the range of from 1.0 inch to one yard, and in a chain width dimension that is orthogonal to the chain height dimension within a range of from 0.25 inches to one foot.

Preferably the first hook 602 and the second hook 606 are shaped and sized to have respective internal hook radii in the range of from 0.0625 inches to six inches.

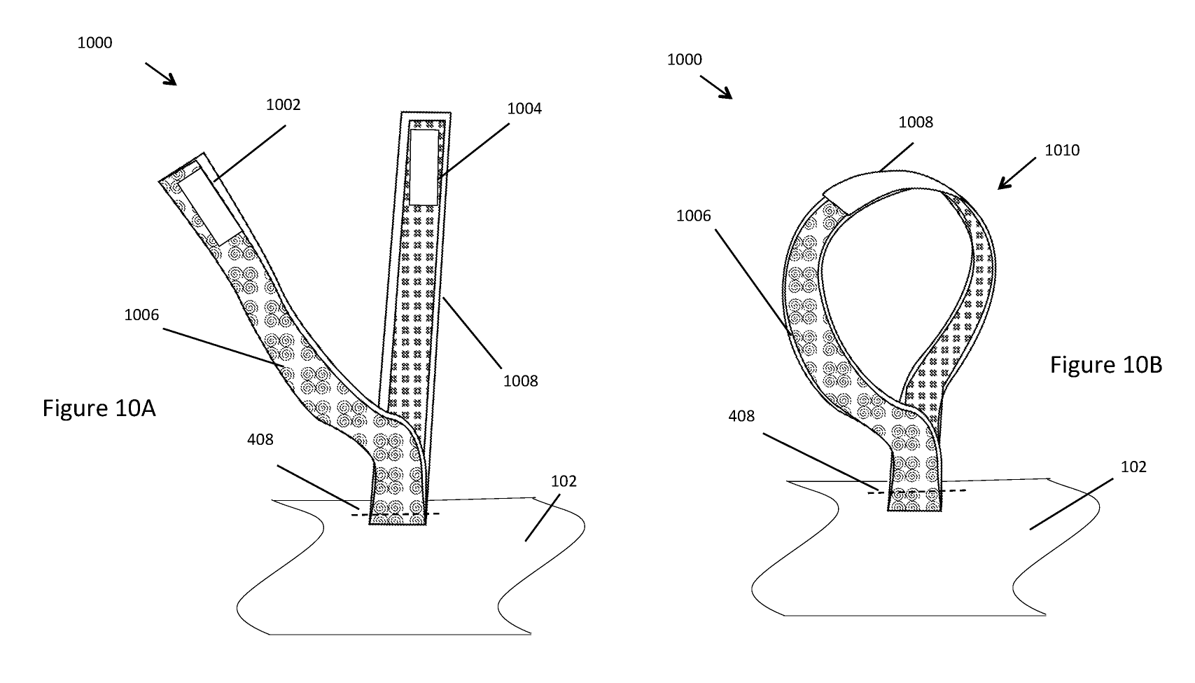

Referring now generally to the Figures and particularly FIG. 10A and 10B, FIG. 10A is a detailed perspective view of a hook-and-loop fastener assembly 1000 adapted for attachment to the fabric sheet 102, shown in the open position, and FIG. 10B presents the hook-and-loop fastener assembly 1000 fastened together using a matched pair of hook-and-loop material strips 1002 & 1004.

The hook-and-loop assembly 1000 includes a pair of straps 1006 & 1008, wherein both straps 1006 & 1008 are together sewn to the fabric sheet 102 using thread 1002, and wherein a first strap 1006 is attached to hook material strip 1002 and a second strap 1008 is attached to the loop material strip 1004, such that when the hook material strip 1002 and the loop material strip 1004 are pressed together and attached, the two straps 1006 & 1008 form a loop 1010 that is attached to the fabric 102, as shown in FIG. 10B.

Preferably the straps 1006 & 1008 extend away from the fabric sheet 102 in a length dimension within the range of from 1.0 inch to one yard, and in a width dimension orthogonal to the height dimension within a range of from 0.25 inches to one foot.

In understanding the scope of the present invention, the term “comprising” and its derivatives, as used herein, are intended to be open ended terms that specify the presence of the stated features, elements, components, groups, integers, and/or steps, but do not exclude the presence of other unstated features, elements, components, groups, integers and/or steps. The foregoing also applies to words having similar meanings such as the terms, “including”, “having” and their derivatives. Also, the terms “part,” “section,” “portion,” “member” or “element” when used in the singular can have the dual meaning of a single part or a plurality of parts. Finally, terms of degree such as “substantially”, “about” and “approximately” as used herein mean a reasonable amount of deviation of the modified term such that the end result is not significantly changed.

While selected embodiments have been chosen to illustrate the invented system, it will be apparent to those skilled in the art from this disclosure that various changes and modifications can be made herein without departing from the scope of the invention as defined in the appended claims. For example, the size, shape, location or orientation of the various components can be changed as needed and/or desired. Components that are shown directly connected or contacting each other can have intermediate structures disposed between them. The functions of one element can be performed by two, and vice versa. The structures and functions of one embodiment can be adopted in another embodiment, it is not necessary for all advantages to be present in a particular embodiment at the same time. Every feature which is unique from the prior art, alone or in combination with other features, also should be considered a separate description of further inventions by the applicant, including the structural and/or functional concepts embodied by such feature(s). Thus, the foregoing descriptions of the embodiments according to the present invention are provided for illustration only, and not for the purpose of limiting the invention as defined by the appended claims and their equivalents.

I claim:

1. A portable privacy screen comprising:
a flexible, opaque sheet having a top edge;
a first magnet at least partially encompassed within a first tab, the first tab extending from the top edge of the sheet;
a second magnet at least partially encompassed within a second tab, the second tab extending from the top edge of the sheet; and
a drawstring assembly, the drawstring assembly having a cord and a tightening element, the cord having a first cord end and a second cord end, wherein the tightening element is slidably coupled with the cord and disposed between the first cord end and the second cord end, and wherein the first cord end is attached to the sheet, and the second cord end is attached to the sheet distally from the first cord end.

2. The portable privacy screen of claim 1, wherein the first cord end and the second cord end are attached to the sheet proximate to the sheet top edge.

3. The portable privacy screen of claim 1, wherein the first tab is visibly distinguishable by surface coloration from the second tab.

4. The portable privacy screen of claim 3, wherein the first tab presents a first color and the second tab presents a second color, wherein the second color is visually distinguishable from the first color.

5. The portable privacy screen of claim 1, further comprising an additional magnet attached to the sheet.

6. The portable privacy screen of claim 5, further comprising a plurality of magnets, wherein each magnet of the plurality of magnets is attached to the sheet.

7. The portable privacy screen of claim 1, wherein the first tab is coupled to the sheet at a first corner, wherein the first corner is formed by the top edge and a first side edge.

8. The portable privacy screen of claim 7, further comprising a third magnet at least partially encompassed within a third tab, the third tab extending from the first side of the sheet.

9. The portable privacy screen of claim 7, wherein the first tab extends from the top edge of the sheet.

10. The portable privacy screen of claim 1, wherein the second tab is coupled to the sheet at a second corner, wherein the second corner is formed by the top edge and a second side edge.

11. The portable privacy screen of claim 10, further comprising a fourth magnet at least partially encompassed within a fourth tab, the fourth tab extending from the second side of the sheet.

12. The portable privacy screen of claim 11, wherein the second tab extends from the top edge of the sheet.

13. The portable privacy screen of claim 10, further comprising a fifth magnet at least partially encompassed within a fifth tab, the fifth tab extending from the top edge of the sheet and the fifth tab disposed between the first tab and the second tab.

14. The portable privacy screen of claim 1, wherein the sheet further comprises a bottom side located distally from the top edge and the drawstring assembly is disposed between the top edge and the bottom side.

15. The portable privacy screen of claim 8, wherein the second tab is coupled to the sheet at a second corner, wherein the second corner is formed by the top edge and a second side edge.

16. The portable privacy screen of claim 15, further comprising a fourth magnet at least partially encompassed within a fourth tab, the fourth tab extending from the second side of the sheet.

17. The portable privacy screen of claim 16, wherein the second tab extends from the top edge of the sheet.

18. The portable privacy screen of claim 17, wherein the second tab extends from the top edge of the sheet.

19. The portable privacy screen of claim 18, further comprising a fifth magnet at least partially encompassed within a fifth tab, the fifth tab extending from the top edge of the sheet and the fifth tab disposed between the first tab and the second tab.

20. The portable privacy screen of claim 1, further comprising an additional magnet at least partially encompassed within the first tab, whereby the first tab at least partially encompasses the first magnet and the additional magnet.

21. The portable privacy screen of claim 1, further comprising a second drawstring assembly, the drawstring assembly having a second cord and a second tightening element, the second cord having a primary cord end and a secondary cord end, wherein the second tightening element is slidably coupled with the second cord and disposed between the primary cord end and the secondary cord end, and wherein the primary cord end is attached to the sheet, and the secondary cord end is attached to the sheet distally from the primary cord end, whereby the inclusion of two drawstring assemblies gives the screen increased resistance to wind and precipitation in certain deployments.

22. The portable privacy screen of claim 1, further comprising a lashing hook, the lashing hook coupled with the opaque sheet.

23. A method comprising coupling portable privacy screen to a vehicle, the vehicle having at least one rotatably coupled vehicle door, the screen comprising a sheet and at least two magnetic tabs and a drawstring coupled to the sheet, the method comprising:
rotating the vehicle door from a closed position;
removably coupling at least one of the magnetic tabs to the vehicle and draping a first portion of the sheet along an exterior of the vehicle door;
removably coupling at least one other of the magnetic tabs to the vehicle and draping a second portion of the sheet between the vehicle door and the vehicle.
